(19) United States
(12) Patent Application Publication
(10) Pub. No.: US 2025/0174927 A1
(43) Pub. Date: May 29, 2025

(54) CONNECTOR

(71) Applicant: YAZAKI CORPORATION, Tokyo (JP)

(72) Inventors: Isao Kameyama, Makinohara-shi (JP); Atsuhito Saito, Makinohara-shi (JP)

(21) Appl. No.: 18/932,564

(22) Filed: Oct. 30, 2024

(30) Foreign Application Priority Data
Nov. 29, 2023 (JP) 2023-201220

(51) Int. Cl. H01R 13/436

(52) U.S. Cl. CPC H01R 13/4362

(57) ABSTRACT

There is provided a connector including a spacer attached to a housing of the connector in a second direction intersecting with a first direction. The spacer has a terminal locking portion protruding in the second direction. The spacer is switchable between a temporary locking state and a final locking state in accordance with a position of the spacer in the second direction with respect to the housing, the temporary locking state being a state of the spacer in which the terminal locking portion is locked to the housing without abutting on a terminal of the connector, and the final locking state being a state of the spacer in which movement of the terminal toward one side in the first direction is restricted by locking the terminal locking portion to the housing in the state of the spacer in which the terminal locking portion abuts on the terminal.

### CROSS-REFERENCE TO RELATED APPLICATIONS

This application is based on and claims priority under 35 USC 119 from Japanese Patent Application No. 2023-201220 filed on Nov. 29, 2023, the contents of which are incorporated herein by reference.

### TECHNICAL FIELD

The present disclosure relates to a structure of a connector used for connecting cable lines.

### BACKGROUND ART

In an automobile and the like, a large number of connectors are used to connect and fix terminals of a plurality of wirings when the large number of wirings (cable lines) are connected to a large number of electric components. In this connector, it is required that each terminal is reliably fixed and that the connector in a state in which each terminal is fixed can be connected to another connector to reliably connect the wirings.

Particularly, JP2015-032562A describes a connector capable of reliably fixing the terminals. In the structure, each terminal is (temporarily) fixed to a resin housing that forms a body of the connector, and then a spacer is fixed to the housing, thereby reliably fixing each terminal. At this time, since the fixed state of each terminal can be visually recognized in the temporarily fixed state before the final fixing (final locking) of the spacer, the terminal is prevented from being fixed in an inappropriate state.

In the above connector, a position of the terminal in the housing, particularly, a position along an extending direction of the wirings, is fixed by the spacer. However, depending on dimensional accuracy of the housing, the spacer, and the like, a gap is formed between the housing and the spacer so that rattle may occur in the terminals. Due to the rattle, the degree of contact between the terminals after the connection of the connector may become unstable.

When the rattle increases, the electrical connection between the terminals may be cut off. Further, for example, as a wiring for transmitting a video signal by a camera, a coaxial cable in which a shielded layer is provided on an outer side of a core wire may be used for noise reduction.

When the coaxial cable is fixed to the connector as described above, even if the electrical connection between the terminals is not cut off due to the rattle, noise may be mixed in the video signal due to the rattle. That is, in the case where the coaxial cable is used, the occurrence of the rattle becomes a particularly serious problem.

### SUMMARY OF INVENTION

According to an illustrative aspect of the present disclosure, a connector fixes a cable line inside the connector, the connector being configured such that the cable line is electrically connected to a counterpart cable line fixed inside a counterpart connector in response to a connection of the connector and the counterpart connector, and the connector being connected to the counterpart connector by moving from one side to the other side in a first direction. The connector includes: an insulating housing inside which the cable line is fixed; a terminal configured to electrically connect with the counterpart cable line, the terminal being connected to a wiring of the cable line on the other side in the first direction of the cable line, and being provided inside the housing to be electrically connected to the counterpart cable line when the connector and the counterpart connector are connected to each other; and a spacer that is made of an elastic material, and that is attached to the housing by moving from one side to the other side in a second direction intersecting the first direction, the spacer having a terminal locking portion protruding toward the other side in the second direction.

The spacer is configured to switch between a temporary locking state and a final locking state in accordance with a position of the spacer in the second direction with respect to the housing, the temporary locking state being a state of the spacer in which the terminal locking portion is locked to the housing without abutting on the terminal, and the final locking state being a state of the spacer in which movement of the terminal toward the one side in the first direction is restricted by locking the terminal locking portion to the housing in the state of the spacer in which the terminal locking portion abuts on the terminal.

### BRIEF DESCRIPTION OF DRAWINGS

FIG. 1A is a perspective view showing a state in which a connector according to an embodiment is connected, and FIG. 1B is a perspective view showing a state before the connector is connected;

FIG. 2A is a perspective view showing a condition of internal cable lines before the connector according to the embodiment is connected, and FIG. 2B is a perspective view showing a condition of the internal cable lines in a connected state of the connector;

FIG. 3A is a perspective view showing a structure on a distal end side of cable lines in the connector according to the embodiment, and FIG. 3B is a perspective view showing a structure on a distal end side of cable lines in a connector to be connected to the connector as shown in FIG. 3A;

FIGS. 4A and 4B are cross-sectional views showing a simplified structure in a plan including central axes of the two cable lines in the connector according to the embodiment;

FIGS. 5A to 5C are perspective views showing a terminal structure of the cable line in the connector according to the embodiment;

FIGS. 6A to 6D are external appearance views of a spacer used in the connector according to the embodiment viewed in four directions;

FIG. 7A is a perspective view of a housing used in the connector according to the embodiment, FIG. 7B is an enlarged view of a portion to which the spacer is attached, and

FIG. 7C is a side view thereof;

FIGS. 8A to 8C are cross-sectional views showing a process until the cable lines (terminals) are fixed in the housing in the connector according to the embodiment;

FIGS. 9A to 9C are perspective views showing a positional relationship between the terminal and the spacer in the process until the cable line (terminal) is fixed in the housing in the connector according to the embodiment;

FIGS. 10A and 10B are enlarged perspective views showing a positional relationship between the flange portion and a terminal locking portion in a temporary locking state (FIG. 10A) and a final locking state (FIG. 10B) when assembling the connector according to the embodiment;

FIGS. 11A and 11B are views of the positional relationship between the flange portion and the terminal locking portion in the temporary locking state (FIG. 11A) and the final locking state (FIG. 11B) when assembling the connector according to the embodiment, as viewed from two directions; and

FIGS. 12A and 12B are views of a positional relationship between a flange portion and a terminal locking portion in a temporary locking state (FIG. 12A) and a final locking state (FIG. 12B) when assembling a modification of the connector according to the embodiment, as viewed from two directions.

### DESCRIPTION OF EMBODIMENTS

A connector according to an embodiment of the present disclosure will be described. In the connector, each terminal of four cable lines is formed in a housing. At this time, as in the technique described in JP2015-032562A, when a spacer is fixed from the state in which the terminals is temporarily fixed, the terminals (cable lines) are fixed to the housing. At this time, since the terminals are fixed in a state biased by the spacer toward a side where a connector to be connected to the connector is provided, rattle is prevented.

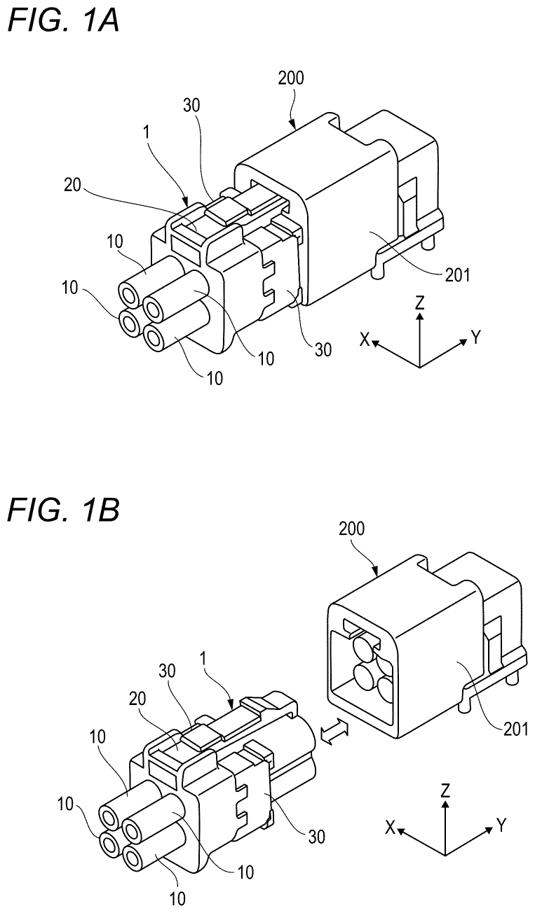

FIG. 1A is a perspective view showing a form when a connector 1 is connected to a substrate side connector 200, and FIG. 1B is a perspective view showing a form before they are connected. Here, the substrate side connector 200 is fixed to a surface of a substrate (not shown). In FIG. 1A, a direction of attachment or detachment of the connector 1 with respect to the substrate side connector 200 is a y direction (first direction), a normal direction of the substrate is a z direction, and a direction perpendicular to the y direction and the z direction is an x direction (second direction). In FIGS. 1A and 1B, the connector 1 is connected to the substrate side connector 200 by moving from a negative side (one side) in the y direction (first direction) to a positive side therein.

In the substrate side connector 200, four substrate side cable lines are fixed inside a substrate side connector housing 201 made of a resin material. The substrate side cable lines are appropriately connected to a pattern on the substrate for electrical connection in the substrate.

In the connector 1 side, four cable lines 10 are fixed in a housing 20 made of a resin material. When the connector 1 is attached to the substrate side connector 200, each of the cable lines 10 is electrically connected to each of the substrate side cable lines. Here, the substrate side cable line and the cable line 10 are coaxial cables, and as will be described later, a core wire is provided on a central axis side, and a braided wire (shielded wire) is provided on an outer side of the core wire via an insulating layer. Both the core wire and the braided wire extend along an extending direction of these cable lines 10. When the connector 1 and the substrate side connector 200 are connected, the core wire and the braided wire of the cable line 10 provided on the connector 1 side are electrically connected to the core wire and the braided wire of the corresponding substrate side cable line on the substrate side connector 200 side, respectively. Here, spacers 30 are attached to the housing 20 from both sides in the x direction.

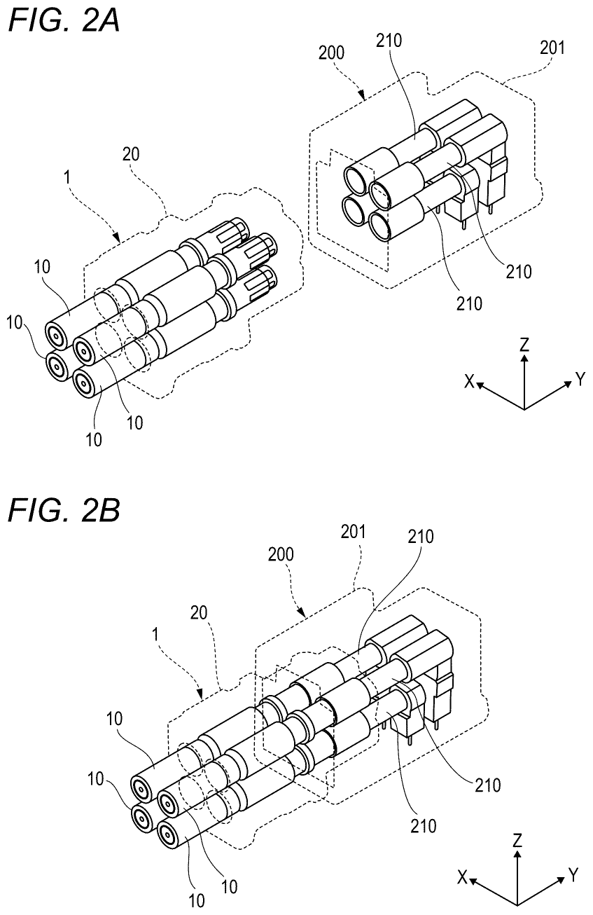

FIG. 2A shows a form of the four cable lines 10 on the connector 1 side before the connector 1 and the substrate side connector 200 are connected, and four (only three in the drawing) substrate side cable lines 210 on the substrate side connector 200, and FIG. 2B shows a form of the cable lines 10 and the substrate side cable lines 210 when the connector 1 and the substrate side connector 200 are connected.

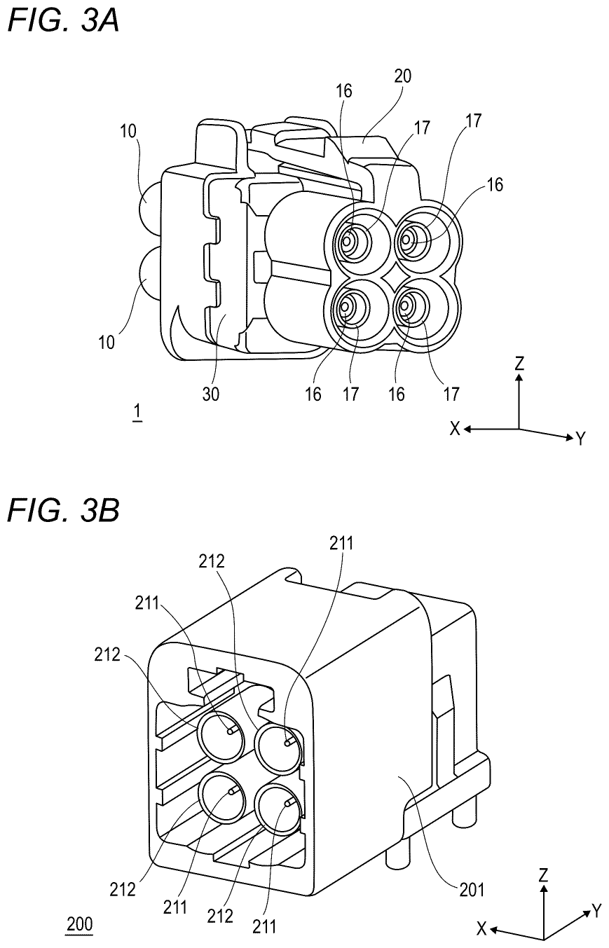

FIGS. 3A and 3B are perspective views of the connector 1 and the substrate side connector 200 viewed from a direction different from that of FIGS. 1A and 1B. FIG. 3A shows a structure on a distal end side of the cable lines 10 in the connector 1, and FIG. 3B shows a structure on a distal end side of the substrate side cable lines 210 in the substrate side connector 200.

In FIG. 3A, an inner housing 16 having a small opening on a central axis of the cable line 10 and an outer terminal (terminal) 17 of a substantially cylindrical shape surrounding the inner housing 16 are formed at a distal end of each cable line 10. An inner terminal 15 (not shown) to be described later is provided in the inner housing 16. Correspondingly, in FIG. 3B, an elongated metallic substrate side inner terminal 211 disposed on a central axis of the substrate side cable line 210, and a substantially cylindrical substrate side outer terminal 212 surrounding the substrate side inner terminal 211 are provided at a distal end of the substrate side cable line 210. In the state of FIG. 2B in which the connector 1 and the substrate side connector 200 are connected, the cable line 10 and the substrate side cable line 210 are connected by abutting the inner terminal 15 on the substrate side inner terminal 211 and abutting the outer terminal 17 on the substrate side outer terminal 212.

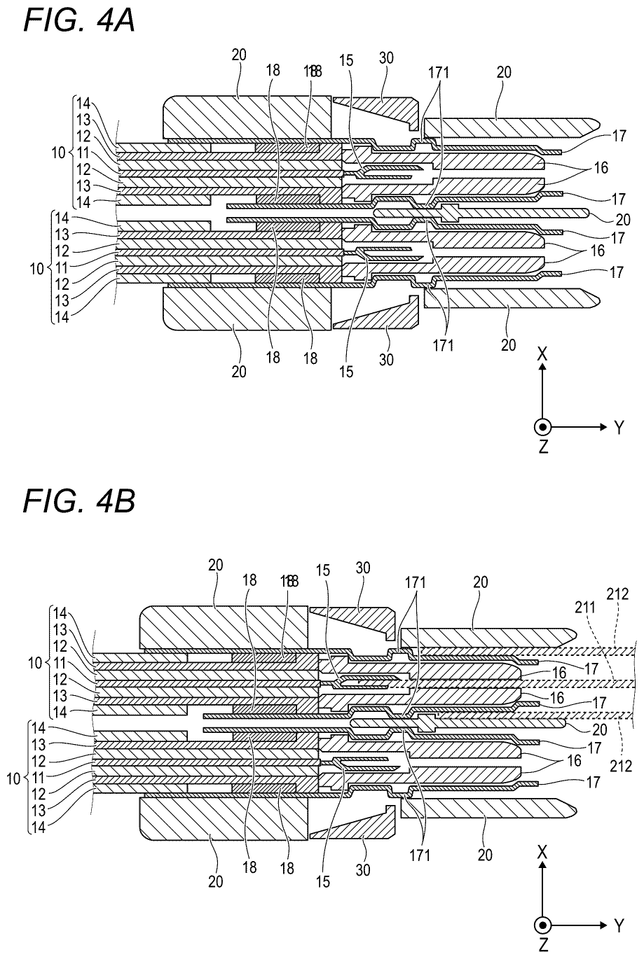

FIGS. 4A and 4B are diagrams of a simplified cross-sectional structure of the connector 1 in an xy plane including the central axes of the two cable lines 10 arranged in the x direction on a z-direction negative side in the state of FIG. 1A, and a simplified structure of a housing 20 side related thereto, respectively. FIG. 4A shows a situation before the connector 1 and the substrate side connector 200 are connected, and FIG. 4B shows a situation after the connector 1 and the substrate side connector 200 are connected. Here, a description of a lance to be described later is omitted. The same applies to a structure related to the two cable lines arranged in two in the x direction on a z-direction positive side in the state of FIG. 1A.

In FIGS. 4A and 4B, the cable lines 10 are fixed in the housing 20 at upper and lower sides of FIGS. 4A and 4B. Each of the cable lines 10 includes a thin core wire (first wiring) 11 extending on the central axis along the y direction, a metallic mesh-shaped braided wire (shielded wire or second wiring) 13 provided on an outer side of the core wire 11 via an insulating layer 12, and an insulating coating layer 14 covering the braided wire 13 on a further outer side. The insulating layer 12, the braided wire 13, and the covering layer 14 are formed to surround the core wire 11. The core wire 11 and the braided wire 13 can be used as wirings in the cable line 10. This structure is similarly applied to the substrate side cable line 210, and the core wire and the braided wire in the substrate side cable line 210 are connected to the substrate side inner terminal 211 and the substrate side outer terminal 212 in FIG. 3B.

A distal end side on a y-direction positive side in the cable line 10 becomes a terminal in the connector 1. Therefore, the metallic inner terminal 15 that is a terminal of the core wire 11 and is shaped to sandwich the substrate side inner terminal 211 on the y-direction positive side is connected to an end portion side of the core wire 11. The end portion side on which the inner terminal 15 is provided is covered with the substantially tubular inner housing 16 made of an insulating resin material. A small opening through which the substrate side inner terminal 211 is inserted is formed on the y-direction positive side of the inner housing 16.

The outer terminal (terminal) 17 having a substantially tubular shape and made of metal is attached to an outer side of the inner housing 16. The outer terminal 17 is connected to the braided wire 13 on a y-direction negative side with respect to the inner housing 16, and is fixed to the braided wire 13 (cable line 10) by sandwiching a circular sleeve 18 attached to the braided wire 13.

A cable line accommodation hole is formed in the housing 20 such that the cable line 10 having the above structure on the distal end side is fitted. By fitting the above structure to the accommodation hole, each cable line 10 is fixed to the housing 20. Although only two cable lines are shown in FIGS. 4A and 4B, the other two cable lines 10 shown in FIGS. 2A and 2B have the same structure and are similarly fixed to the housing 20.

In FIG. 4B, when the connector 1 is connected to the substrate side connector 200, the elongated substrate side inner terminal 211 is inserted into the opening of the inner housing 16 and clamped at a tip end portion of the inner terminal 15. On the other hand, an inner diameter of the substantially cylindrical substrate side outer terminal 212 is set slightly larger than an outer diameter of the substantially cylindrical outer terminal 17. As shown in FIG. 4B, the substrate side outer terminal 212 can be fitted and attached to an outer side of the outer terminal 17. Accordingly, the core wire 11 and the braided wire 13 in the cable line 10 can be electrically connected to the core wire and the braided wire in the substrate side cable line 210, respectively.

In the structure of FIGS. 4A and 4B, a positional relationship of the inner terminal and the outer terminal 17 as terminals on a cable line 10 side with respect to the housing can be determined with high accuracy in the x direction and the z direction. On the other hand, as compared with the x direction, it is not easy to determine the positional relationship along the y direction that is the extending direction of the cable line 10 with high accuracy. That is, the positions of the inner terminal 15 and the outer terminal 17 in the y direction are relatively likely to vary with each other, which easily causes rattle between the terminals when the inner terminal 15 and the outer terminal 17 are connected.

When the rattle occurs, the electrical connection between the cable line 10 and the substrate side cable line 210 becomes unstable. Particularly, even when disconnection does not occur between the two cable lines due to the rattle, for example, when a video signal is transmitted through these wires, noise may be mixed into the video signal. Therefore, it is required to reduce the rattle of the terminals in the y direction.

On the other hand, in the connector 1, the terminals in the cable line 10 are biased to the y-direction positive side (the side on which the substrate side connector 200 is provided) by the spacers 30 attached to the housing 20 in FIGS. 1A and 1B. Accordingly, the rattle is reduced.

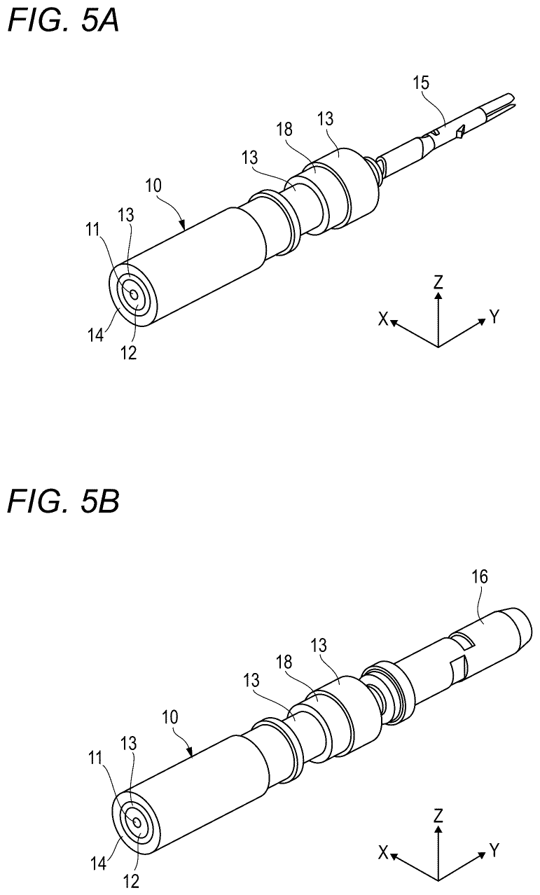

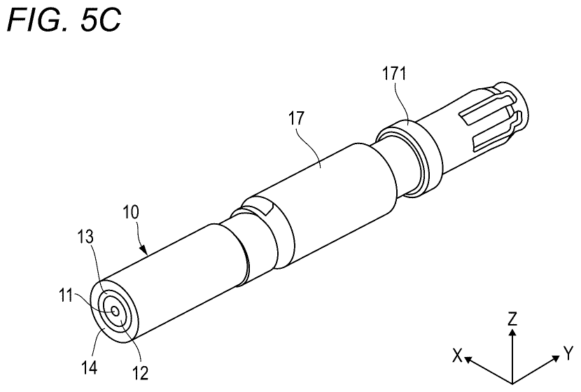

A specific structure for this will be described. FIGS. 5A to 5C are perspective views showing a terminal structure on the cable line 10 side. Here, FIG. 5A shows a state before the inner housing 16 and the outer terminal 17 are attached to the cable line 10, FIG. 5B shows a state where the inner housing 16 is attached thereto, and FIG. 5C shows a state where the outer terminal 17 is further attached thereto.

As shown in FIG. 5A, an elongated inner terminal 15 is attached to and exposed on the y-direction positive side in the cable line 10. On the other hand, as shown in FIG. 5B, the inner terminal 15 is protected by attaching the substantially cylindrical inner housing 16 made of an insulating resin material. Thereafter, as shown in FIG. 5C, the inner housing 16 is covered and protected by attaching the metallic outer terminal 17 having a substantially cylindrical shape. At this time, since the inner housing 16 is insulative, insulation between the inner terminal 15 and the outer terminal 17 is also ensured.

At this time, the outer terminal 17 is firmly fixed to the cable line 10 via the sleeve 18. Therefore, by fixing the position of the outer terminal 17 in the housing 20, the positions of the cable line 10, the inner terminal 15, and the like are also fixed.

Here, as shown in FIG. 5C, the substantially cylindrical outer terminal 17 having the central axis in the y direction is formed with a flange portion 171 having a large diameter locally in the y direction. The outer terminal 17 and the cable line 10 can be biased to the y-direction positive side by using the flange portion 171.

The biasing is performed by the spacer 30. Hereinafter, the structure of the spacer and the housing 20 for achieving this will be described. As shown in FIGS. 1A and 1B, since the spacer 30 is attached to the housing 20 symmetrically on the negative side and on the positive side in the x direction, the structure for attaching the spacer 30 to the housing 20 side is also a symmetric structure on the negative side and the positive side in the x direction. In FIGS. 1A and 1B, the spacer 30 attached to the x-direction negative side biases the terminals of the two cable lines 10 on the x-direction negative side as described above, and the spacer 30 attached to the x-direction positive side biases the terminals of the two cable lines 10 on the x-direction positive side as described above. Hereinafter, particularly, the spacer 30 attached to the x-direction negative side and the structure and operation related thereto will be described. The structure of the spacer 30 attached to the x-direction positive side and the operation related thereto are symmetrical thereto in the x direction.

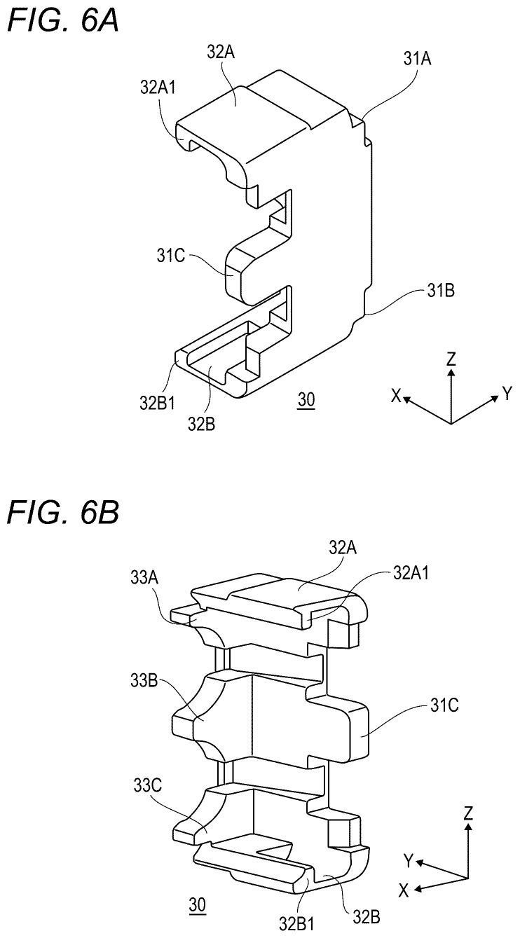

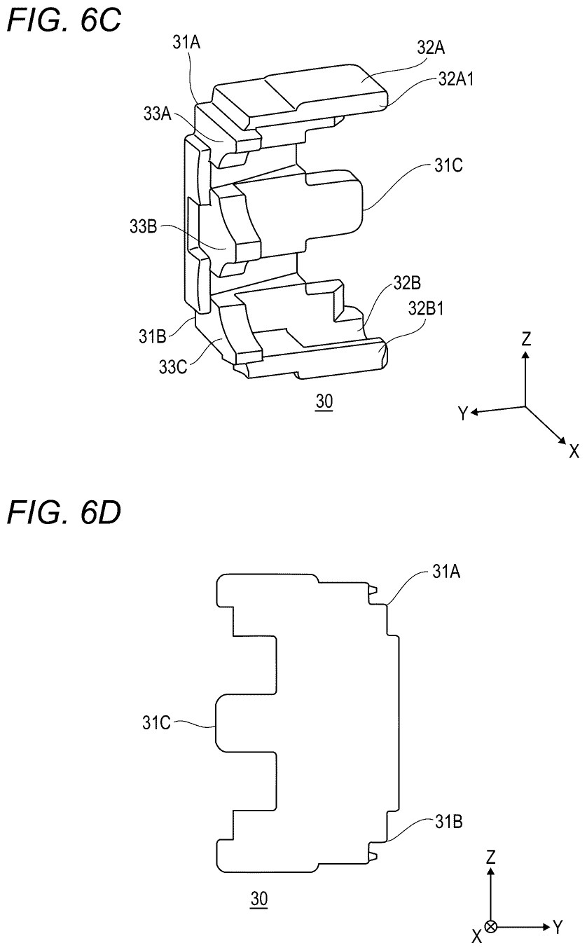

The spacer 30 is made of an elastic material softer than the housing 20. FIGS. 6A to 6D are external appearance views of the spacer 30 viewed from various directions, FIGS. 6A to 6C are perspective views of the spacer 30 viewed from various sides, and FIG. 6D is a side view of the spacer 30 viewed from the x-direction negative side. The spacer 30 is attached to the housing 20 from the negative side (one side) in the x direction (second direction) in FIGS. 1A and 1B toward the positive side (the other side).

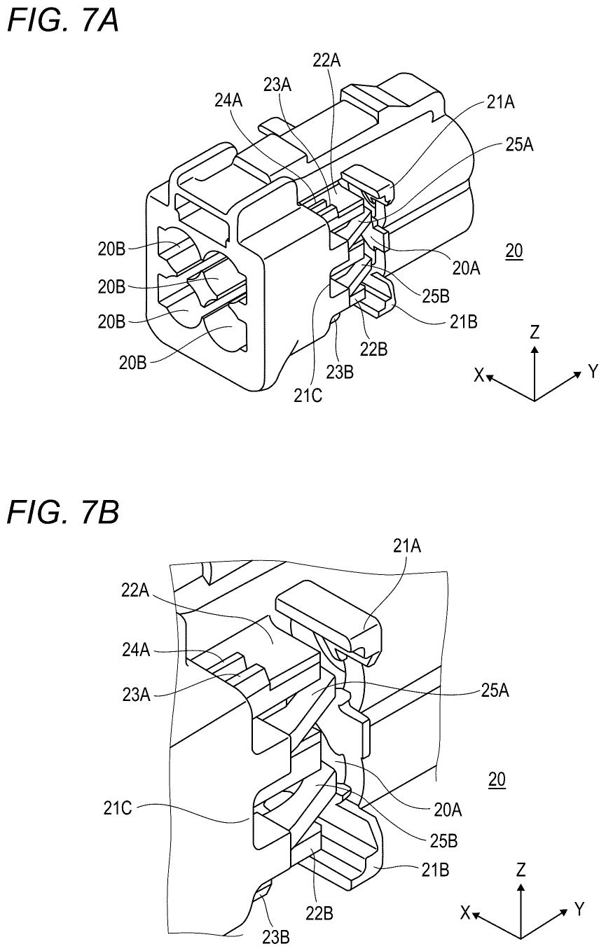

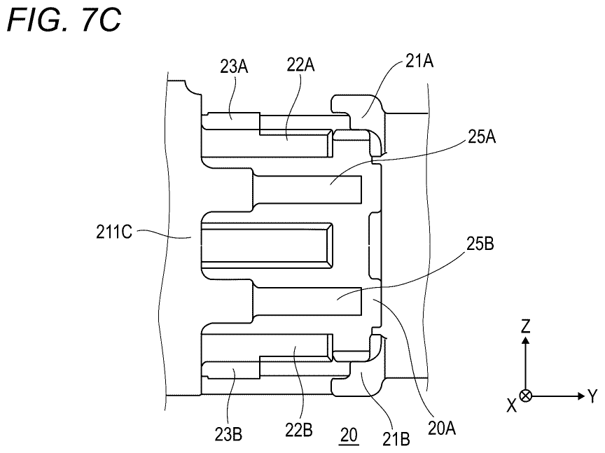

FIG. 7A is a perspective view of the housing 20 in a state in which the spacer 30 is not attached, and FIG. 7B is an enlarged view of a portion thereof where the spacer 30 is attached. FIG. 7C is a side view of the same portion as in FIG. 7B viewed from the x-direction negative side. The shape of FIG. 6D in the spacer 30 corresponds to the shape of FIG. 7C in the housing 20.

The housing 20 is made of an elastic material (resin material) harder than the spacer 30, and a spacer accommodation portion 20A, which is an opening for receiving the spacer 30, is provided in the housing 20. Further, as shown in FIG. 7A, four cable line accommodation holes 20B for inserting the four cable lines 10, a tip end side of which has the shape shown in FIG. 5C, respectively are formed on an end face of the housing 20 on the y-direction negative side.

In FIG. 7C, an inner face of the spacer accommodation portion 20A on the y-direction positive side is provided with spacer guide portions 21A, 21B, and 21C which have shapes corresponding to and guide a guided portion 31A, which is a region near vertices on the y-direction positive side and the z-direction positive side of spacer 30 in FIG. 6D, a guided portion 31B, which is a region near vertices on the y-direction positive side and the z-direction negative side, and a guided portion 31C, which protrudes locally to the y-direction negative side near the middle in the z direction, respectively. As shown in FIG. 6D, steps are provided in the guided portions 31A and 31B, and corresponding steps are also provided in the guide portions 21A and 21B in FIG. 7C, so that the spacer 30 can be fitted and attached to the spacer accommodation portion 20A from the x-direction negative side (a front side of a paper) to the x-direction positive side (a back side of the paper) in FIG. 7C.

As shown in FIGS. 6A to 6C, arms 32A and 32B protruding toward the x-direction positive side are formed at a positive side end portion and a negative side end portion of the spacer 30 in the z direction, respectively. A housing locking portion 32A1 bent toward the z-direction negative side is formed at a tip end of the arm 32A, and a housing locking portion 32B1 bent toward the z-direction positive side is formed at a tip end of the arm 32B.

On the other hand, in FIG. 7B, spacer support portions 22A and 22B, which protrude toward the x-direction negative side and support the spacer 30 at the time of attachment, are provided on the positive side and the negative side in the z direction with respect to the spacer guide portion 21C in the housing 20, respectively. On the z-direction positive side of the spacer support portion 22A, a temporary locking portion 23A and a final locking portion 24A are respectively formed to correspond to the housing locking portion 32A1 on the spacer 30 side and protrude locally on the z-direction positive side so as to lock the housing locking portion 32A1 when the spacer 30 is attached to the housing accommodation hole 20A. The temporary locking portion 23A is formed on the x-direction negative side with respect to the final locking portion 24A and is formed in parallel with the final locking portion 24A. Similarly, a temporary locking portion 23B and a final locking portion 24B (not shown) are formed symmetrically in the z direction with respect to the temporary locking portion 23A and the final locking portion 24A on the z-direction negative side of the spacer support portion 22B.

As described above, since the spacer 30 (the arms 32A and 32B) is formed of a soft elastic material, the arm 32A can be deformed such that the housing locking portion 32A1 rides over the temporary locking portion 23A and the final locking portion 24A when the spacer 30 is attached to the spacer accommodation portion 20A. The same applies to the housing locking portion 32B1 (arm 32B) side. Therefore, in FIG. 7B, when the spacer 30 is pushed from the x-direction negative side, in a state immediately after the housing locking portion 32A1 rides over the temporary locking portion 23A, the spacer 30 is fixed in the spacer accommodation portion 20A in a state in which the housing locking portion 32A1 is locked to the temporary locking portion 23A. When the spacer 30 is further pushed, in a state immediately after the housing locking portion 32A1 rides over the final locking portion 24A, the spacer 30 is fixed in the spacer accommodation portion 20A further toward the x-direction positive side in a state in which the housing locking portion 32A1 is locked to the final locking portion 24A. The same applies to the housing locking portion 32B1 (arm 32B) side.

Hereinafter, the fixed state in which the housing locking portion 32A1 (32B1) is locked to the temporary locking portion 23A (23B) in this manner is referred to as a temporary locking state, and the state in which spacer 30 is further pushed from this state so that housing locking portion 32A1 (32B1) is locked to the final locking portion 24A (24B) and fixed in the spacer accommodation portion 20A further toward the x-direction positive side is referred to as a final locking state. That is, there are two states in which the spacer 30 is attached to the housing 20 in the connector 1: the temporary locking state and the final locking state in which the spacer 30 is further pushed. The state when the connector 1 is actually used is the final locking state, and the temporary locking state is a state achieved in the middle of assembling the connector 1.

Further, in FIG. 7B, in the spacer accommodation portion 20A in the housing 20, beam-shaped lances 25A and 25B are respectively formed on the positive side and the negative side in the z direction so as to be inclined toward the x-direction positive side (the central axis side of the corresponding cable lines 10 as they extend to the y-direction positive side. As will be described later, the lances 25A and 25B are used as retainers for preventing the upper and lower cable lines 10 in FIGS. 4A and 4B from coming off when the cable lines are attached to the housing 20, and are provided at certain positions of the cable lines 10 in the z direction.

The spacer 30 attached to the x-direction positive side in FIGS. 1A and 1B and the structure corresponding to the spacer 30 on the housing 20 side are symmetrical in the x direction with the structure described above. Therefore, the spacer 30 attached to the x-direction positive side can also take the two states, that is, the temporary locking state and the final locking state. The lances are also symmetrically formed.

Here, as shown in FIGS. 6B and 6C, on the y-direction positive side, terminal locking portions 33A, 33B, and 33C protruding toward the x-direction positive side are sequentially formed in the spacer 30 from the z-direction positive side toward the negative side thereof. As will be described later, in the final locking state of the spacer 30, the terminal locking portion 33A abuts on the terminal (outer terminal 17) of the upper cable line 10 in FIGS. 4A and 4B, the terminal locking portion 33B abuts on the terminal (outer terminal 17) of the upper cable line 10 and the terminal (outer terminal 17) of the lower cable line 10, and the terminal locking portion 33C abuts on the terminal (outer terminal 17) of the lower cable line 10, thereby biasing each terminal (cable line 10) to the y-direction positive side. That is, in the final locking state, the terminal locking portions provided in the spacer 30 abut on the respective terminals and bias the terminals to the y-direction positive side. On the other hand, in the temporary locking state, the respective terminal locking portions do not abut on the respective terminals.

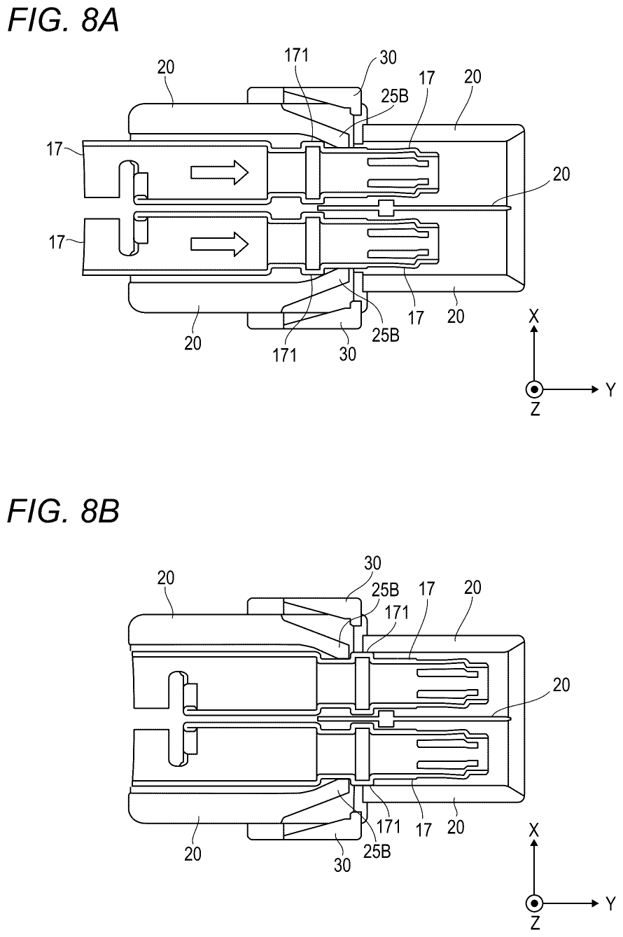

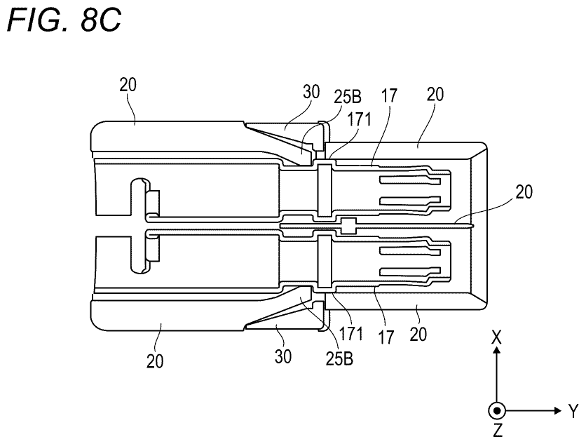

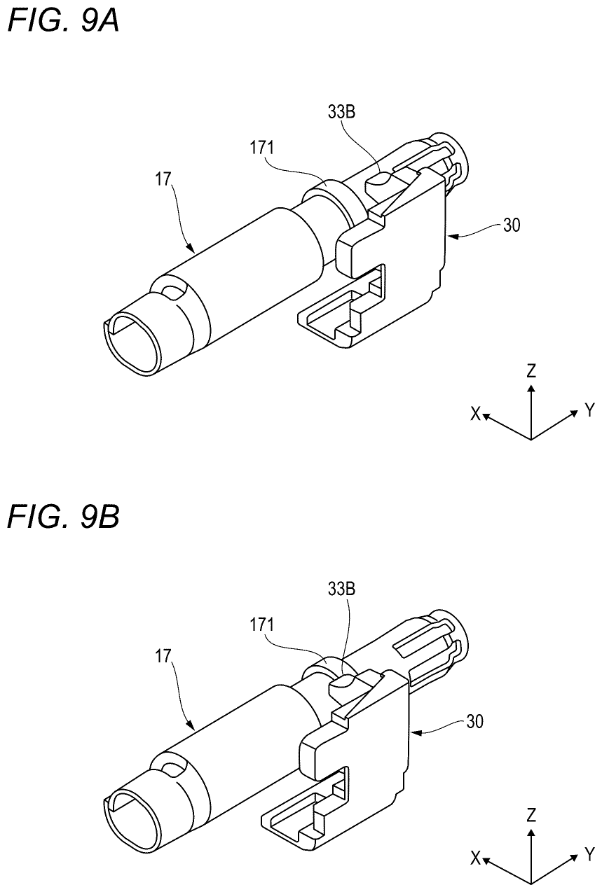

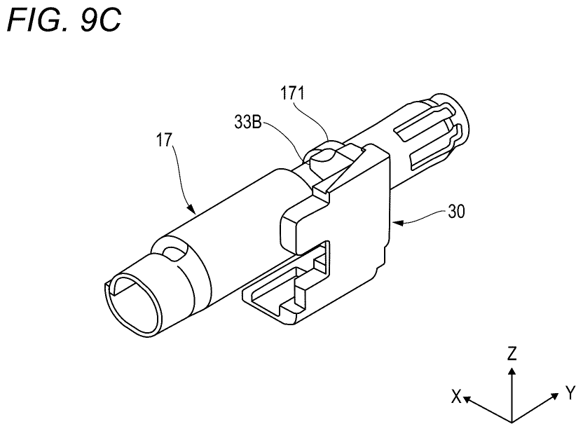

Hereinafter, an assembling process in which the spacer 30 is brought into the final locking state after the attaching of each cable line 10 to the housing 20 in the above structure will be described. FIGS. 8A to 8C are cross-sectional views corresponding to FIGS. 4A and 4B showing the assembling process, and here, a cross-sectional view of the xy plane along the central axes of the two cable lines 10 on the z-direction negative side in FIGS. 1A and 1B is shown. Further, as described above, since the inner terminal 15 and the like on the cable line side are indirectly fixed to the outer terminal 17, the position of the inner terminal 15 and the like changes in conjunction with the position of the outer terminal 17. Therefore, only the outer terminals 17, the housing 20, and the spacer 30 are shown in FIGS. 8A to 8C, and the other components are omitted. FIGS. 9A to 9C are perspective views showing a state (positional relationship) of only the outer terminal 17 and the spacer 30 in each state of FIGS. 8A to 8C.

In FIG. 8A, first, in a state in which the spacer 30 is in the temporary locking state and is attached to the housing 20, the cable line 10 of which the distal end side is in the form of FIG. 5C is inserted into the cable line accommodation hole 20B from the y-direction negative side toward the positive side thereof. At this time, as shown in FIGS. 4A and 4B, the flange portion 171 is formed to have a large diameter locally in the outer terminal 17, but in the state shown in FIG. 8A, the flange portion 171 is located on the y-direction negative side with respect to a tip end portion of the lance 25B and is also separated from the terminal locking portions 33B and 33C of the spacer 30, so that the outer terminal 17 (cable line 10) can be easily brought into the state shown in FIG. 8A.

From this state, if the cable line 10 (outer terminal 17) is further pushed toward the y-direction positive side, the flange portion 171 abuts on the lance 25B. As described above, the lance 25B is inclined toward the central axis side of the cable line 10 as it extends to the y-direction positive side, and since the lance 25B is elastically deformable, the flange portion 171 can be moved toward the y-direction positive side with respect to a tip end of the lance 25B, as shown in FIG. 8B. On the other hand, moving the flange portion 171 to the y-direction negative side from this state is not easy because the tip end portion of the lance 25B becomes an obstacle. That is, the lance 25B functions to prevent the cable line 10 (outer terminal 17) from coming off.

FIGS. 9A and 9B show the positional relationship between the outer terminal 17 (flange portion 171) and the spacer 30 (terminal locking portion 33B) in the state of FIGS. 8A and 8B. In these states, the flange portion 171, the terminal locking portion 33B, and the terminal locking portion 33C (not shown in FIGS. 9A to 9C) do not abut on each other. Therefore, the spacer 30 (the terminal locking portions 33B and 33C) does not become an obstacle in the above work.

When each spacer 30 is pushed toward the housing 20 side from the state shown in FIG. 8B, the spacer 30 can be brought into the final locking state shown in FIG. 8C. In this case, tip ends of the terminal locking portions 33B and 33C are set to abut on the flange portion 171 on the y-direction negative side of the flange 171 and to protrude toward the central axis side of the cable line 10 (outer terminal 17) with respect to an outer periphery of the flange portion 171. Therefore, the flange portion 171 does not abut on the terminal locking portion 33B in FIGS. 9A and 9B, whereas the flange portion 171 abuts on the terminal locking portion 33B in FIG. 9C.

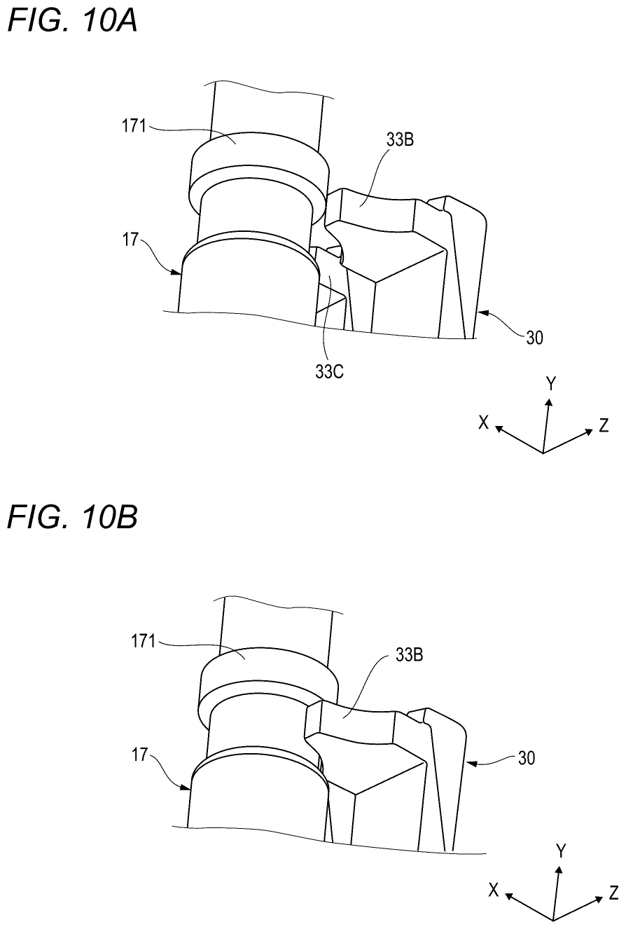

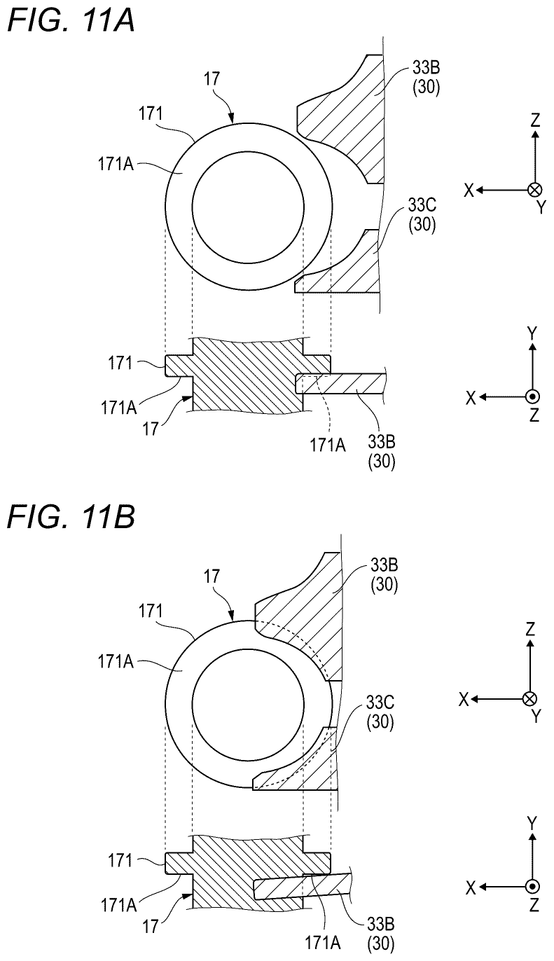

FIGS. 10A and 10B are enlarged perspective views showing the flange portion 171 and conditions around the flange portion 171 in FIG. 9B corresponding to the temporary locking state and FIG. 9C corresponding to the final locking state, respectively. FIG. 11A is a schematic front view (upper side) of the positional relationship between the flange portion 171 and the terminal locking portions 33B and 33C in the temporary locking state (FIGS. 9B and 10A) viewed from the y-direction negative side and a top view (lower side) viewed from the z-direction positive side. FIG. 11B shows a similar view in the final locking state (FIGS. 9C and 10B).

In FIGS. 10A and 11A corresponding to the temporary locking state, the flange portion 171 or a flange surface 171A, which is an annular surface of flange portion 171 on the y-direction negative side, does not abut on the terminal locking portions 33B and 33C. On the other hand, in FIGS. 10B and 11B corresponding to the final locking state, since the terminal locking portions 33B and 33C move to the x-direction positive side from the state of FIGS. 10A and 11A, the flange surface 171A abuts on surfaces of the terminal locking portions 33B and 33C on the y-direction positive side. At this time, as shown in FIG. 11A, when the surfaces of the terminal locking portions 33B and 33C on the y-direction positive side are set to be slightly on the y-direction positive side with respect to the flange surface 171A in this state, and vertices of the flange portion 171A and the terminal locking portions 33B and 33C are formed in an R-shape, the terminal locking portions 33B and 33C can be elastically deformed by pushing the spacer 30, and can easily transition to a state shown in FIG. 11B.

In the state shown in FIGS. 10B and 11B, the flange portion 171 is biased to the y-direction positive side by elastic forces of the terminal locking portions 33B and 33C. Therefore, (i) as shown in FIG. 9A, with the spacer 30 in the temporary locking state, the cable line 10 is inserted into the cable line accommodation hole 20B in the housing 20, (ii) then the flange portion 171 is moved further back (toward the y-direction positive side) with respect to the tip end of the lance 25B as shown in FIG. 9B, (iii) and then the spacer 30 is pushed to enter the final locking state, thereby fixing the cable line 10 to the housing 20 and forming the connector 1. At this time, since the outer terminal 17, the inner terminal 15 indirectly fixed thereto, and the like are also biased toward the y-direction positive side (a side on which the substrate side connector 200 is provided) by the spacer 30, the rattle between the terminals at the time of connection is prevented. At this time, the spacer 30 is biased conversely to the x-direction negative side from the flange portion 171 (outer terminal 17) side, but the movement of the spacer 30 toward the x-direction negative side is restricted by the housing locking portion 32A1 (32B1) being locked by the final locking portion 24A (24B). Therefore, in this state, the spacer 30 is stably attached to the housing 20.

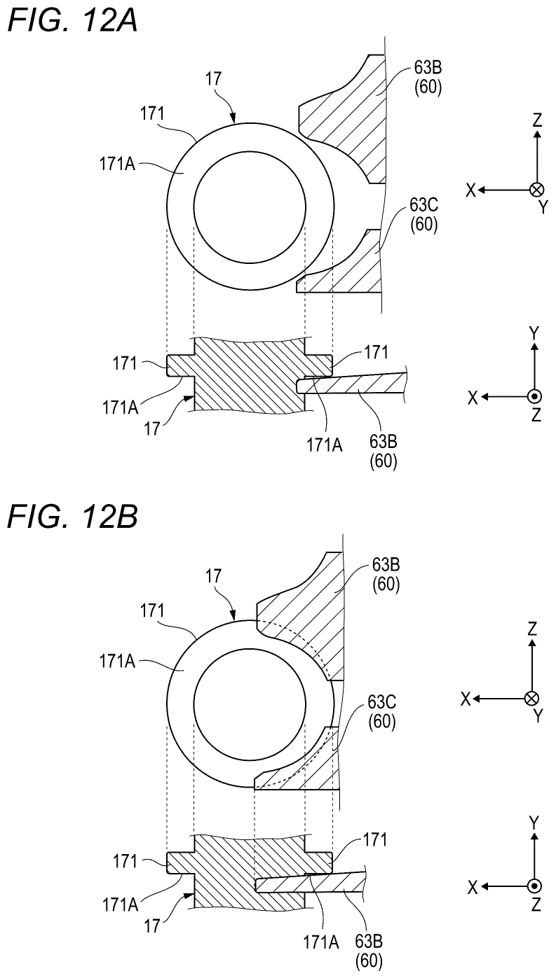

The shape of the terminal locking portion can be appropriately set as long as the terminal locking portion does not abut on the flange portion 171 at the time of the temporary locking and abuts on the flange portion 171 (the outer terminal 17) at the time of the final locking so as to bias the flange portion 171 to the y-direction positive side. FIGS. 12A and 12B are views corresponding to FIGS. 11A and 11B in a case where a spacer 60 as a modification including the terminal locking portion is used.

In the spacer 60, cross-sectional shapes along the xy plane are different from those of the terminal locking portions 33A, 33B, and 33C, and cross-sectional shapes of the terminal locking portions 63B and 63C shown in FIGS. 12A and 12B are tapered to become narrower (thinner) toward the central axis side of the cable line 10 (outer terminal 17). The same applies to a terminal locking portion (corresponding to the terminal locking portion 33A) positioned on the most z-direction positive side (not shown). Other structures are similar to those of the spacer 30.

In FIG. 12A in which the spacer 60 is in the temporary locking state, as in FIG. 11A, the terminal locking portions 63B and 63B do not abut on the flange portion 171. However, when the spacer 60 is pushed toward the x-direction positive side in order to bring the spacer 60 into the final locking state, the tip ends of the terminal locking portions 63B and 63C do not abut on the flange portion 171, and a region on a base side (x-direction negative side) with respect to the tip ends of the terminal locking portions 63B and 63C can abut on the flange surface 171A. Therefore, compared to the spacer 30, the spacer 60 can be pushed more smoothly, and the final locking state can be easily achieved. Similarly, the shape of the terminal locking portions can be appropriately set such that the above-described operation is smoothly performed.

In the above example, the terminal locking portions in the spacer 30 abut on the y-direction negative side of the flange portion 171 (outer terminal 17) from the outer side viewed from the central axis of the cable line 10 (outer terminal 17) in the final locking state, and accordingly, the outer terminal 17 and the cable line 10 are biased to the y-direction positive side. Thus, by abutting the terminal locking portions on the flange portion 171 from the y-direction negative side (a side opposite to the side on which the substrate side connector 200 is connected), the outer terminal 17 and the like can be biased toward the y-direction positive side (the side on which the substrate side connector 200 is provided).

However, for example, even when the terminal locking portions made of an elastic material abut on the flange portion 171 toward the x-direction positive side, movement of the outer terminal 17 in the housing 20 can be prevented. That is, in order to prevent the movement (rattle) of the outer terminal 17, the terminal locking portions do not necessarily abut on the flange portion 171 from the y-direction negative side.

As described above, the rattle that is a problem in the outer terminal 17 occurs mainly in the y direction (the direction of attachment or detachment between the connector and the substrate side connector), but the rattle in the outer terminal (cable line) may also occur in other directions. The rattle is caused, for example, by rotation of the cable line 10 (outer terminal 17) around the central axis. In contrast, for example, even when the terminal locking portions made of the elastic material abut on the flange portion 171 from the x-direction negative side, the rotation of the outer terminal 17 can be prevented. In this case, although the effect may be less than that when the terminal locking portions abut from the y-direction negative side as described above, movement of the outer terminal 17 in the y direction can still be prevented in this case. That is, as long as the movement of the outer terminal 17 at least to the y-direction negative side (the side opposite to the side on which the substrate side connector 200 is provided) can be restricted to a certain degree, a place where the flange portion 171 (outer terminal 17) abuts on the terminal locking portion can be appropriately set. When the terminal locking portions are not abutted in the y direction, it is not necessary to provide a flange portion having a large diameter locally along the y direction on a terminal side.

Further, as described above, the cable line 10 is a coaxial cable, but the cable line to be used may have any structure as long as an outer terminal and the like that can be similarly biased by the terminal locking portions can be used. The shape of the outer terminal (terminal) and the terminal locking portions can also be appropriately set accordingly. However, in the case of using the coaxial cable in which noise is easily mixed due to the rattle of the terminal, the above structure is particularly effective.

Further, as shown in FIGS. 1A and 1B and the like, in the above example, the four cable lines 10 are used, and the two spacers 30 provided with the terminal locking portions and the like corresponding thereto are used. Even when the number of cable lines is other than four, similarly, a spacer where the terminal locking portions corresponding thereto are provided can be appropriately used. In this case, since the number of the spacers is three or more or one, the rattle of the terminals of all the cable lines can be reduced. The arrangement of the cable lines in the connector can be set as appropriate accordingly.

In the above example, the structure on the connector 1 side in FIGS. 1A and 1B is shown, and a similar structure can be used on the substrate side connector side. That is, the above structure can be adopted in any connector used for electrical connection of the cable lines.

The present disclosure has been described above based on the embodiment. This embodiment is merely an example, and it will be understood by those skilled in the art that various modifications are possible in the combination of the components, and that the modifications are also within the scope of the present disclosure.

According to a first aspect of the present disclosure, a connector (1) fixes a cable line inside the connector (1), the connector (1) being configured such that the cable line (10) is electrically connected to a counterpart cable line (210) fixed inside a counterpart connector (200) in response to a connection of the connector (1) and the counterpart connector (200), and the connector (1) being connected to the counterpart connector (200) by moving from one side to the other side in a first direction. The connector (1) includes: an insulating housing (20) inside which the cable line (10) is fixed; a terminal (15, 17) configured to electrically connect with the counterpart cable line (210), the terminal (15, 17) being connected to a wiring of the cable line (10) on the other side in the first direction of the cable line (10), and being provided inside the housing (20) to be electrically connected to the counterpart cable line (210) when the connector (1) and the counterpart connector (200) are connected to each other; and a spacer (30) that is made of an elastic material, and that is attached to the housing (20) by moving from one side to the other side in a second direction intersecting the first direction, the spacer (30) having a terminal locking portion (33A, 33B, 33C) protruding toward the other side in the second direction. The spacer (30) is configured to switch between a temporary locking state and a final locking state in accordance with a position of the spacer (30) in the second direction with respect to the housing (20), the temporary locking state being a state of the spacer (30) in which the terminal locking portion (33A, 33B, 33C) is locked to the housing (20) without abutting on the terminal (15, 17), and the final locking state being a state of the spacer (30) in which movement of the terminal (15, 17) toward the one side in the first direction is restricted by locking the terminal locking portion (33A, 33B, 33C) to the housing (20) in the state of the spacer (30) in which the terminal locking portion (33A, 33B, 33C) abuts on the terminal (15, 17).

According to a second aspect of the present disclosure, in the first aspect, the terminal (15, 17) includes a flange portion (171) in which an outer diameter around a central axis along the first direction is locally increased in the first direction.

According to a third aspect of the present disclosure, in the second aspect, in the final locking state, the terminal locking portion (33A, 33B, 33C) abuts on the flange portion (171) from the one side in the second direction.

According to a fourth aspect of the present disclosure, in the third aspect, when the spacer (30) shifts from the temporary locking state to the final locking state, a thickness of the terminal locking portion (33A, 33B, 33C) along the first direction is reduced toward the other side in the second direction such that an end portion on the other side in the second direction of the terminal locking portion (33A, 33B, 33C) does not abut on the flange portion (171) and a portion on the one side in the second direction with respect to the end portion of the terminal locking portion (33A, 33B, 33C) abuts on the flange portion (171).

According to a fifth aspect of the present disclosure, in the first or second aspect, in the final locking state, the terminal locking portion (33A, 33B, 33C) abuts on a surface on the one side of the terminal (15, 17) in the second direction.

According to a sixth aspect of the present disclosure, in the first or second aspect, the cable line (10) includes: a first wiring (11) extending in the first direction; and a second wiring (13) insulated from the first wiring (11) and provided on an outer side around an extending direction of the first wiring (11). The terminal (15, 17) is connected to the second wiring (13).

According to the present disclosure, the connector in which the rattle of the terminals is prevented can be obtained.

What is claimed is:

1. A connector fixing a cable line inside the connector, the connector being configured such that the cable line is electrically connected to a counterpart cable line fixed inside a counterpart connector in response to a connection of the connector and the counterpart connector, and the connector being connected to the counterpart connector by moving from one side to the other side in a first direction, the connector comprising:
an insulating housing inside which the cable line is fixed;
a terminal configured to electrically connect with the counterpart cable line, the terminal being connected to a wiring of the cable line on the other side in the first direction of the cable line, and being provided inside the housing to be electrically connected to the counterpart cable line when the connector and the counterpart connector are connected to each other; and
a spacer that is made of an elastic material, and that is attached to the housing by moving from one side to the other side in a second direction intersecting the first direction, the spacer having a terminal locking portion protruding toward the other side in the second direction, wherein
the spacer is configured to switch between a temporary locking state and a final locking state in accordance with a position of the spacer in the second direction with respect to the housing, the temporary locking state being a state of the spacer in which the terminal locking portion is locked to the housing without abutting on the terminal, and the final locking state being a state of the spacer in which movement of the terminal toward the one side in the first direction is restricted by locking the terminal locking portion to the housing in the state of the spacer in which the terminal locking portion abuts on the terminal.

2. The connector according to claim 1, wherein
the terminal includes a flange portion in which an outer diameter around a central axis along the first direction is locally increased in the first direction.

3. The connector according to claim 2, wherein
in the final locking state, the terminal locking portion abuts on the flange portion from the one side in the second direction.

4. The connector according to claim 3, wherein
when the spacer shifts from the temporary locking state to the final locking state, a thickness of the terminal locking portion along the first direction is reduced toward the other side in the second direction such that an end portion on the other side in the second direction of the terminal locking portion does not abut on the flange portion and a portion on the one side in the second direction with respect to the end portion of the terminal locking portion abuts on the flange portion.

5. The connector according to claim 1, wherein
in the final locking state, the terminal locking portion abuts on a surface on the one side of the terminal in the second direction.

6. The connector according to claim 1, wherein
the cable line includes: a first wiring extending in the first direction; and a second wiring insulated from the first wiring and provided on an outer side around an extending direction of the first wiring, and
the terminal is connected to the second wiring.
